(19) United States
(12) Patent Application Publication
(10) Pub. No.: US 2026/0100824 A1
(43) Pub. Date: Apr. 9, 2026

(54) SECURE SPLIT KNOWLEDGE MULTI-PARTY SECRET GENERATION

(71) Applicant: LokBlok, Inc., Wilmington, DE (US)

(72) Inventor: William Reid Carlisle, St. Petersburg, FL (US)

(73) Assignee: LokBlok, Inc., Wilmington, DE (US)

(21) Appl. No.: 18/092,294

(22) Filed: Dec. 31, 2022

Related U.S. Application Data
(60) Provisional application No. 63/295,803, filed on Dec. 31, 2021.

(51) Int. Cl. H04L 9/08

(52) U.S. Cl. CPC H04L 9/085; H04L 9/0894

(57) ABSTRACT

A method to calculate a Secret [symbol] as a first function of entropy values received from each of the participants. The calculated Secret S is then split using a second function to create a discrete share for each participant, wherein each discreet share is a function of the corresponding entropy values. Each discrete share may be distributed by non-private communication to the participant corresponding to its supplied entropy first value. Optionally, the Secret [symbol] may be burned after use, but can be recalculated by a subset of the original participants as a third function of their respective entropy value and discrete share. Since the discrete shares are not sufficient to recreate the Secret without knowledge of the corresponding entropy values, the discrete shares may be distributed openly without the need for privacy, and need not be held securely.

This application claims the benefit of and incorporates by reference the text of U.S. Provisional Patent Application No. 63/295,803, filed Dec. 31, 2021, titled “Secure Split Knowledge Multi-Party Secret Generation”.

### FIELD OF INVENTION

The field of the invention is the sharing of secrets in secure multi-party computation and more specifically to methods for generating secrets, and secret shares, in a multi-party computation.

### BACKGROUND

Secret sharing was invented in 1979 by Adi Shamir, “How to share a secret” Communications of the ACM, 22(11):612-13, 1979, and independently at the same time by Bob Blakley, G. R. Blakley, “Safeguarding cryptographic keys” Proceedings of the 1979 AFIPS National Computer Conference, AFIPS Conference Proceedings, vol. 48, AFIPS Press, 1979, pp. 313-317. Meanwhile, secret sharing has become a fundamental cryptographic primitive with a host of applications, most notably in threshold cryptography and secure multi-party computation. See generally, Cramer, et al., Secure Multiparty Computation and Secret Sharing (2015).

As typically implemented secret sharing refers to methods for sharing a given secret among a group, by distributing discrete “shares” of the given secret in such a way that no individual holds any intelligible information about the given secret, but when a sufficient number of individuals combine their “shares”, the given secret may be reconstructed. Whereas insecure secret sharing allows an attacker to gain more information with each share, secure secret sharing is ‘all or nothing’ (where ‘all’ means the necessary number of shares). In other words, the prior art process of secret sharing works from a given secret and splits it into multiple discrete parts.

There are many secret sharing algorithms known to those skilled in the art with reference to this disclosure, also called Threshold Split Knowledge Algorithms (each referred to as a “TSKA”), or simply “split knowledge”. It is generally understood that a (k, n) threshold secret sharing scheme, where k (the “threshold”) and n (the total number of shares) are integers with 0<k≤n, provides a means to “disperse” a secret S into n pieces of data, called shares, such that any number of shares <k jointly give no information on the secret [symbol] , whereas any number of these shares ≥k jointly determine the secret S uniquely (in other words, k shares are needed for reconstruction of the secret [symbol] ).

All TSKA when given a secret S are capable of calculating n discrete outputs. The secret does not need to be kept after it is used (as a seed value, or an encryption key, for example), and may be burned, deleted, destroyed, or otherwise erased. By design, only k of the n shares (k<n) are needed to run the TSKA in reverse and reconstruct the secret S.

The use of secret sharing in multi-party calculations, however, presents special needs, as all of the parties thereto wish to compute jointly not only the reconstruction of the secret, but the secret itself. Further, parties in a multi-party calculation wish to make their inputs to the calculation private, and secure, meaning that no individual party can see the other parties' data. Advantageously, such calculations should be done in a manner that maximizes the entropy of a calculated secret.

There are a myriad of possible embodiments, but prior art systems require private communication by a “dealer” (the actor responsible for running the TSKA) of discrete shares of a secret to each of the n participants sharing that secret, and all splits must be returned to the dealer in order to recalculate the secret. The prior art is deficient, however, because it does not allow for only a threshold number of those participants to reconstruct the resulting secret, and because private communication and storage of the splits is necessary. Therefore, there is a need for a new method which solves these deficiencies of the prior art.

### SUMMARY OF THE INVENTION

The invention meets this need by having the dealer calculate a Secret [symbol] as a first function of entropy values received from each of the participants. The calculated Secret [symbol] is then split using a second function to create a discrete share for each participant, wherein each discreet share is a function of the corresponding entropy values. Each discrete share may be distributed by non-private communication to the participant corresponding to its supplied entropy first value. Optionally, the Secret [symbol] may be burned after use, but can be recalculated by a subset of the original participants as a third function of their respective entropy value and discrete share. Since the discrete shares are not sufficient to recreate the Secret without knowledge of the corresponding entropy values, the discrete shares may be distributed openly without the need for privacy, and need not be held securely.

### DESCRIPTION OF THE DRAWINGS

FIG. 1 is a flow diagram showing the method of the invention.

FIG. 2 is a flow diagram showing optional embodiments of the method of the invention.

FIG. 3 is a graph of one step in an example of one embodiment of the method of the invention.

FIG. 4 is a graph of a further step in an example of one embodiment of the method of the invention.

### DETAILED DESCRIPTION OF THE INVENTION

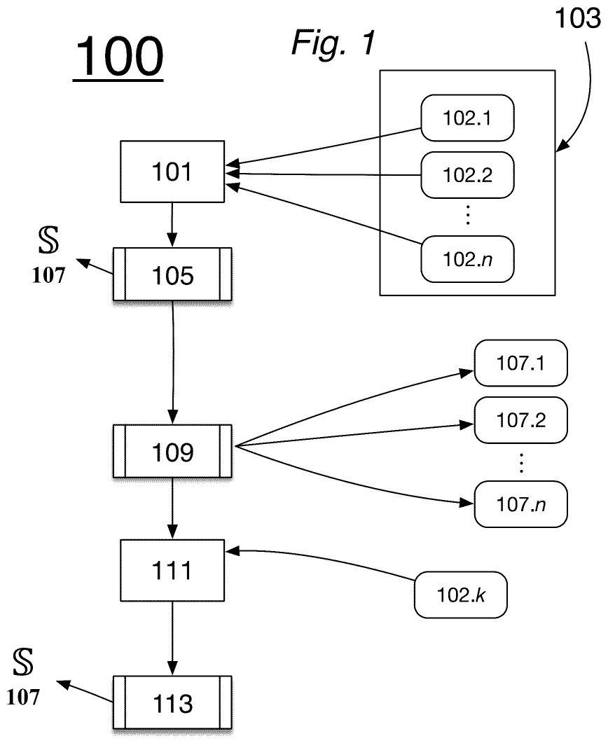

With reference to FIG. 1, the method of the invention 100 comprises receiving 101 a first value 102 from each participant in group 103, said group having n members in which n>1; combining 105 the received n first values to calculate a secret 107; splitting 109 secret 107 into n second values 107.1 . . . 107.n, each of the n second values corresponding to one of the received first values; receiving 111 k third values 102.k, where k<n and each received third value is identical to one of the received first values; and reconstructing 113 the secret 107* as a function of the received third values and their corresponding second values.

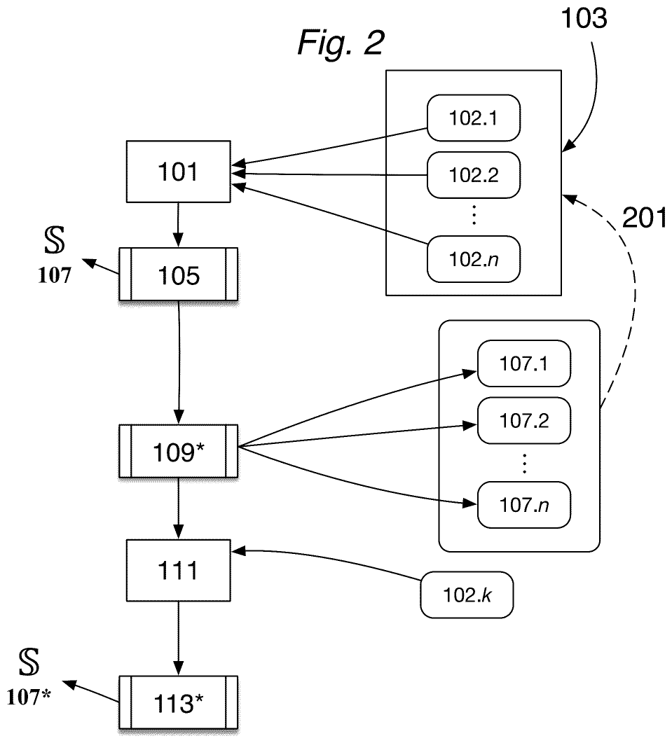

With reference to FIG. 2, there are many optional steps or modifications that may be taken, such as sending 201 each one of the n second values 107.1 . . . 107.n to the group participant corresponding to a received first value; calculating the secret 107 using the Lagrange Interpolating Polynomial where abscissa values are cardinal numbers 1≤x≤n, the y ordinate values are the received n first values, and the secret 107 is the y-intercept; the splitting step 109* is performed using the Shamir Sharing Algorithm, and the received n first values are used as abscissa values; burning the secret after it is used; and recalculating 113* the secret 107* using the Lagrange Interpolating Polynomial where the abscissa values are the k third values, the y ordinate values are k second values corresponding to said third values, and the secret 107* is the y-intercept.

Similar to conventional Shamir Secret Sharing, the essential idea of the scheme is an extension of the Lagrange interpolation theorem, specifically that k points is enough to uniquely determine a polynomial of degree less than or equal to k−1. For instance, 2 points are sufficient to define a line, 3 points are sufficient to define a parabola, 4 points to define a cubic curve and so forth. This invention accomplishes two tasks using Lagrange interpolation (although those skilled in the art will appreciate that other interpolation schemes may be used) for two polynomials rather than one. The first polynomial combines the entropy from n unique sources. The second polynomial splits the resulting random value representing the combined entropy so that only k of the n original participants can recover the secret. To accomplish this a new convention is used for the selection of the x values in the second polynomial. Additionally, the convention for which value, x or y, is considered sensitive and which is non-sensitive is reversed from the prior art. In the second polynomial, the x values are the original entropy input by each participant.

First, entropy from n sources is combined to generate a new random number based on all inputs. Second, split the new random number so that k of the n participants that provided the entropy inputs can recover the new random number.

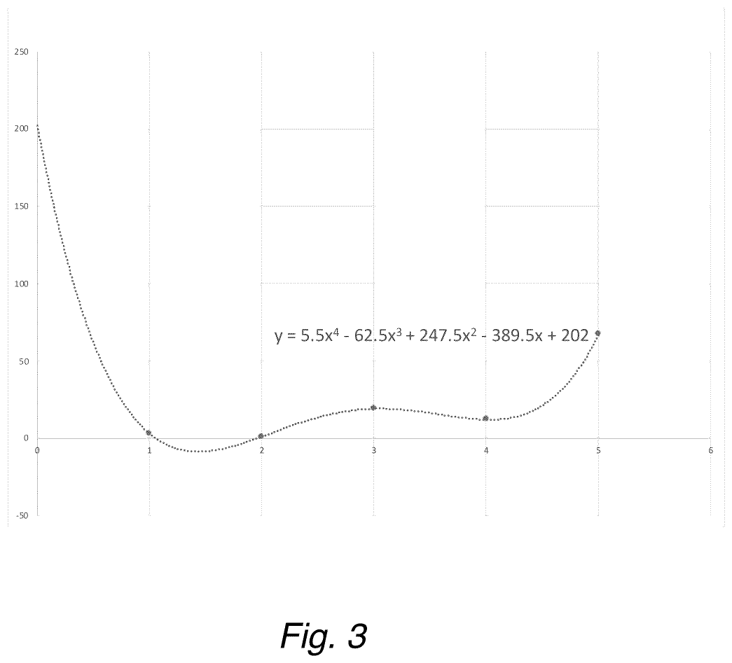

Without departing from the scope of the invention, a simple example will illuminate these steps. In this example I use the Lagrange Interpolating Polynomial, although other combination methods known to those of ordinary skill in the art with reference to this disclosure could be used. Entropy values yₙ received from each of the n sources (here picked at random for the example as 3, 1, 19, 12, and 67) are assigned to nodes xₙ (the nodes being given sequential cardinal values 1, 2, 3, 4, and 5 for convenience) to create n distinct coordinate pairs (xₙ, yₙ): (1, 3); (2, 1); (3, 19); (4, 12); and (5, 67). With reference to FIG. 3, plotting these pairs and fitting a 4th order polynomial curve to the values yields a mapping as shown, with 4th order polynomial equation as shown in the figure. That equation is evaluated to find the y-intercept (e.g., for x=0), yielding, in this example, a value of 202 for the Secret S. Secret S thus represents the combination of entropy from five random sources.

Secret [symbol] is now available to be used for any purpose, such as a key, a Master Key Encryption Key, etc., as will be obvious to those of ordinary skill in the art. Optionally, once the Secret [symbol] has served its purpose, it may be burned and using the method of this invention, it can be reconstructed.

Next, a new splitting polynomial is created using Secret [symbol] (here having value 202) as its y-intercept and random numbers for the other coefficients. If the design is a 2 of 5 secret sharing scheme, the splitting polynomial would be:

$$y = bx + 𝕊 \qquad ( Ex . 1 )$$

For a 3 of 5 secret sharing scheme, the splitting polynomial for this example could be:

$$y = {ax}^{2} + bx + 𝕊 \qquad ( Ex . 2 )$$

And so on for other secret sharing schemes, where the order of the chosen polynomial is k−1.

The splitting polynomial is evaluated at x values equal to the random entropy provided by each participant, in other words, in this example at coordinate pairs (xₙ, yₙ): (3, y₁); (1, y₂); (19, y₃); (12, y₄); and (67, y₅). If b=48 is arbitrarily chosen for a random coefficient, the Secret [symbol] =202, and a 2 of 5 secret sharing scheme is used, the splitting polynomial is:

$$y = 48 x + 202 \qquad ( Ex . 3 )$$

The coordinate pairs then become (xₙ, yₙ): (3, 346); (1, 250); (19, 1114); (12, 778); and (67, 3418), in which the x values are the entropy provided by each of the participants, and the y values are the corresponding share of the Secret.

Note: the x values in this case must remain secret and the y values do not have to remain secret and are non-sensitive values that can be returned to each participant without encryption or privacy.

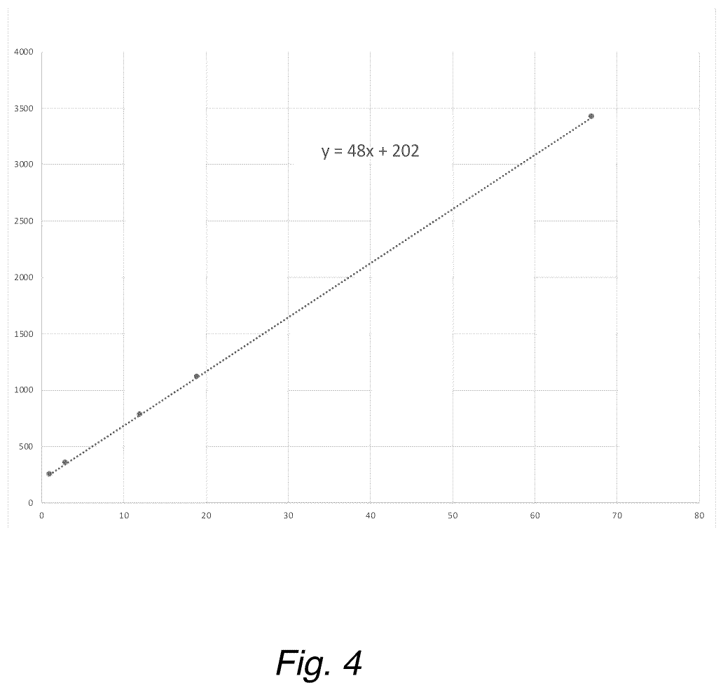

Finally, only two of the participants splits are needed to recover the Secret. With reference to FIG. 4, assume that participants 1 and 5 return their respective first values 3 and 67 (i.e., their original entropy contributions) as “third values.” These are the sensitive values. The two received third values (3 and 67) are matched with the two second values (these are Secret shares which are non-sensitive) corresponding to participants 1 and 5 (e.g., 346 and 3418) forming two coordinate pairs: (3, 346) and (67, 3418), then plotting these coordinate pairs and fitting a curve (in this example a line), yielding the following equation:

$$y = 48 x + 202 \qquad ( Ex . 4 )$$

As is apparent, Equations 3 and 4 are identical, and the method is sufficient to recover the Secret [symbol] (e.g., the y-intercept 202).

Those skilled in the art will appreciate that the described embodiments are exemplary rather than limiting the present invention. Substitute embodiments may be designed by those skilled in the art without departing from the scope of the claims.

1. A method for multi-party calculation of a secret and reconstruction of that secret by a subset of parties, comprising:
receiving a first value from each participant in a group, said group having n members in which n>1;
combining the received first values to calculate a secret;
splitting the secret into n second values, each of the n second values corresponding to one of the received first values;
receiving k third values, where k<n and each received third value is identical to one of the received first values; and
reconstructing the secret as a function of the received k third values and their corresponding second values.

2. The method of claim 1 where the combining step comprises calculating the secret using the Lagrange Interpolating Polynomial, the x abscissa values are the cardinal numbers 1≤x≤n, the received n first values are used as y ordinate values, and the secret is the y-intercept.

3. The method of claim 1 where the splitting step comprises using the Shamir Sharing Algorithm where the received n first values are used as x abscissa values.

4. The method of claim 1, before the reconstructing step, further comprising burning the secret.

5. The method of claim 1, the reconstructing step comprising calculating the secret using the Lagrange Interpolating Polynomial where the x abscissa values are the received k third values, the y ordinate values are corresponding second values, and the secret is the y-intercept.
